(19) United States
(12) Patent Application Publication
(10) Pub. No.: US 2012/0320364 A1
(43) Pub. Date: Dec. 20, 2012

(54) DEVICE AND A METHOD FOR DETERMINING A DISTANCE TO A SURFACE OF A WORKPIECE AND AN ARRANGEMENT AND A METHOD FOR EFFECTING A WORKPIECE

(75) Inventors: Michael Hallberg, Trollhattan (SE); Paw Sten Olsen, Brondby (DK)

(73) Assignee: VOLVO AERO CORPORATION, Trollhättan (SE)

(21) Appl. No.: 13/515,815

(22) PCT Filed: Dec. 14, 2009
(86) PCT No.: PCT/SE2009/000514

§ 371 Date: Jun. 29, 2012

(51) Int. Cl. G01C 3/08

(52) U.S. Cl. 356/4.01

(57) ABSTRACT

A device for determining a distance to a surface of a workpiece includes an arrangement for emitting an energy beam towards the surface. The device includes a contact member with a first surface configured to contact the surface of the workpiece and a second surface facing the energy beam emitting means. The energy beam emitting arrangement is arranged for directing the energy beam to the second surface of the contact member.

### BACKGROUND AND SUMMARY

The present invention relates to a device for determining a distance to a surface of a workpiece, wherein the device comprises a means for emitting an energy beam towards the surface. The invention also relates to an arrangement for effecting the workpiece based on the distance determined by the distance determining means. Further, the invention is related to a method for said distance determination and a method for effecting the workpiece.

During laser welding, it is important to maintain a laser source and a workpiece to be welded at a constant distance with a small tolerance in order to achieve a robust and stable welding process and avoid problems with variations in the welding geometry and that the laser source is not controlled in an optimum way.

An outlet nozzle for a rocket engine may be formed-by a sandwich type of wall structure comprising an inner conical wall, an outer conical wall and a plurality of circumferentially spaced intermediate walls positioned between the inner and outer walls and rigidly connected to the inner and outer walls. Cooling ducts are formed between the intermediate walls and the inner and outer walls.

During manufacturing of such an outlet nozzle, the intermediate walls may be formed integral with the inner wall by providing a conical wall part with initially oversized dimensions/excess material and milling an exterior surface of the conical wall part. The outer conical wall is then positioned in axial alignment with the conical wall part and moved in an axial direction to a final position in contact with the free edges of the intermediate walls. The outer conical wall is then joined to the edges, wherein the oulet j nozzle is formed.

One known way of joining the intermediate, walls to the outer wall is by means of laser welding utilizing a joint tracking technique. Further, a distance determining device in the form of a measuring laser unit is used for determining a distance between the welding laser source and an external surface of the outer wall. During welding, the distance between the welding laser source and the external surface of the j outer wall is continuously controlled in response to the distance determined.

One problem with the distance determination step is that the measuring laser unit is sensitive for reflections, which may result in that the value of the measured distance may vary depending on the reflections from the melt and the structure of the surface at the welding area. For example, the distance value may vary depending on whether the surface is polished and on reflection differencies between different material batches.

The above problem may result in that the geometry and configuration of the weld may vary between different hardwares although the same welding parameters and distance determining device is used.

It is desirable to provide a device for determining a distance to a surface of a workpiece, which creates conditions for a more accurate determination of the distance.

According to an aspect of the invention, a device is provided for determining a distance to a surface of a workpiece, wherein the device comprises a means for emitting an energy beam towards the surface characterized in that the device comprises a contact member with a first surface configured to contact the surface of the workpiece and a second surface facing the energy beam emitting means and that the energy beam emitting means. is arranged for directing the energy beam to the second surface of the contact member.

The distance determination will in this way be stable and robust thanks to the fact that the distance is always measured to the same surface (the second surface facing the energy beam emitting means). In other words, the device is independent from different reflections from different welds and different workpieces.

With the aid of the measured distance, a welding robot or a welding apparatus may be accurately controlled, it being possible to regulate the welding process online.

According to a preferred embodiment of the invention, the second surface of the contact member is located on an opposite side of the contact member in relation to the first surface. Further, the contact member preferably comprises a substantially flat part, which comprises said first and second surfaces. Thus, the contact member may be produced in a cost-efficient way, and may for example be formed by a bent metal sheet.

According to a preferred embodiment of the invention, the device comprises a means for forcing the contact member in contact with said surface of the workpiece during operation. By maintaining the contact member in close contact with the workpiece during operation by said forcing means, an accurate distance determination is achieved. Preferably, said forcing means comprises a flexible element, which is configured to assume a state of higher potential energy in an active state for forcing the contact member in contact with said surface of the workpiece during operation. Said forcing means may for example comprise a helix shaped spring arranged around a bar extending between the energy beam emitting means and the contact member.

According to a further preferred embodiment of the invention, the device comprises a distance determining means operatively connected to the energy beam emitting means for determining the distance based on information associated to the energy beam.

It is desirable to provide an arrangement for controlling a welding operation which affords opportunities for a welded article with a higher weld quality in relation to the prior art.

According to an aspect of the invention, an arrangement is provided for effecting a workpiece, comprising an apparatus configured to effect the workpiece, characterized in that the arrangement comprises the distance determining device mentioned above and that the distance determining device is operatively connected to the apparatus for effecting the workpiece based on the distance determination.

According to a preferred embodiment of the invention, the apparatus is arranged behind the contact member in an direction of movement of the arrangement during operation.

Preferably, the apparatus comprises a welding device. Further, the welding operation is preferably performed utilizing a joint tracking technique for tracking the joint to be welded in combination with the inventive distance determination.

Further preferred embodiments and advantages of the invention emerge from the other claims and the following description.

### BRIEF DESCRIPTION OF FIGURES

The invention will be described in greater detail below with reference to the embodiments shown in the accompanying drawings, in which

FIG. 1 schematically shows a welding arrangement for welding an outlet nozzle for a rocket engine,

FIG. 2 shows an enlarged view of the arrangement according to FIG. 1 from an opposite direction,

FIG. 3 shows a further enlarged view of the arrangement according to FIG. 2, and

FIG. 4 schematically shows the components of the welding arrangement.

### DETAILED DESCRIPTION

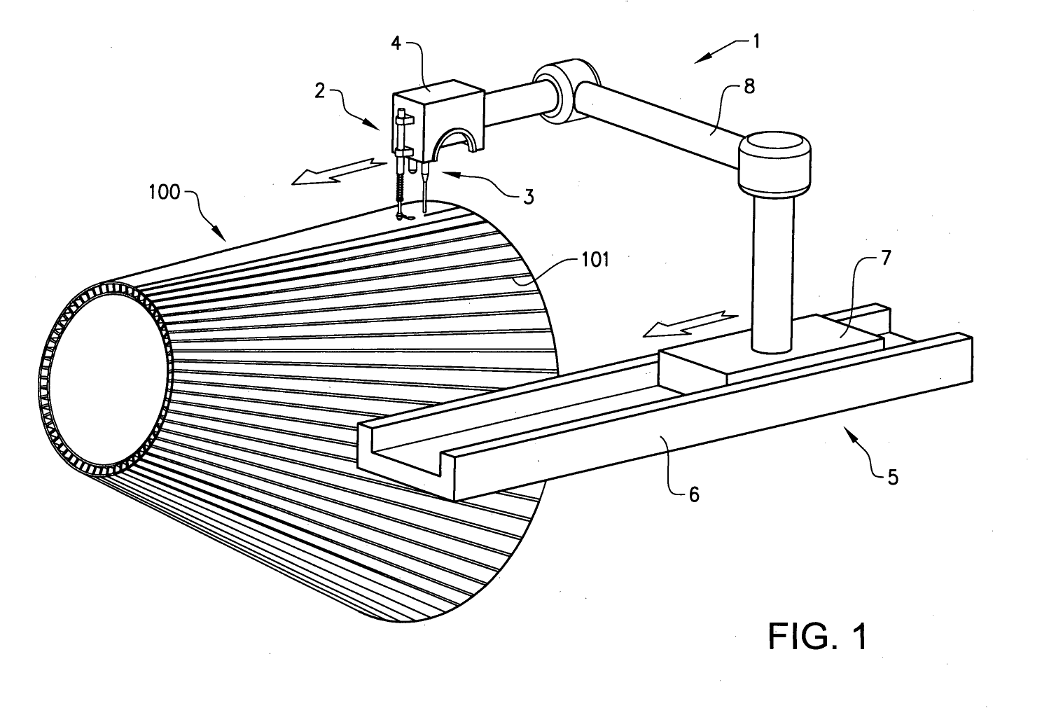

FIGS. 1-4 show a first embodiment of an arrangement 1 configured to effect a workpiece 100. More specifically, FIGS. 1-4 shows a welding arrangement 1. The welding arrangement 1 comprises a device 2 for determining a distance to a surface of a workpiece in the form of an outlet nozzle 100 for a rocket engine. The welding arrangement 1 further comprises an apparatus configured to effect the workpiece 100 in the form of a welding apparatus 3. The welding arrangement 1 comprises a holding means 4, which holds the distance determining device 2 and the welding apparatus 3 in a predetermined relation with regard to each other. Thus, the distance determining device 2 and the welding apparatus 3 are moved in unison during welding. In other words, the distance determining device 2 and the welding apparatus 3 are rigidly connected to each other for maintaining a predetermined mutual spacial relation. Further, the apparatus 3 is arranged behind the contact member 11 in a direction of movement of the arrangement during operation.

According to the embodiment example shown in FIG. 1, a plurality of straight welds 101 are performed. The welding arrangement 1 therefore comprises an arrangement 5 for linear movement of the holding means 4 (and thereby linear movement of the distance determining device 2 and the welding apparatus 3). The arrangement 5 for linear movement of the holding means 4 comprises a straight rail 6 and a sledge 7 configured to move along the rail 6. The holding means 4 is rigidly connected to the sledge 7 via a link arm arrangement 8.

The present invention is aimed primarily at control of laser welding (which is sensitive with regard to focus) but may be used for any method comprising a distance determination. The invention may for example be used in arc welding, specifically TIG (Tungsten Inert Gas), also referred to as GTAW (Gas Tungsten Arc Welding), but can also be used for other fusion welding methods where the energy supply is effected by, for example, gas flame', or by means of another energy supply using, for example, electromagnetic radiation in another spectral range, charged particles, or electric or acoustic heating. The invention can be applied for welding various materials, for example stainless steel, Inconel 718 and Greek-Ascoloy, but is not in any way limited to these materials. In FIGS. 1-3, the invention is shown in a case where welding is performed without filler material. However, the invention is not limited to this but can also be applied for welding with a filler material.

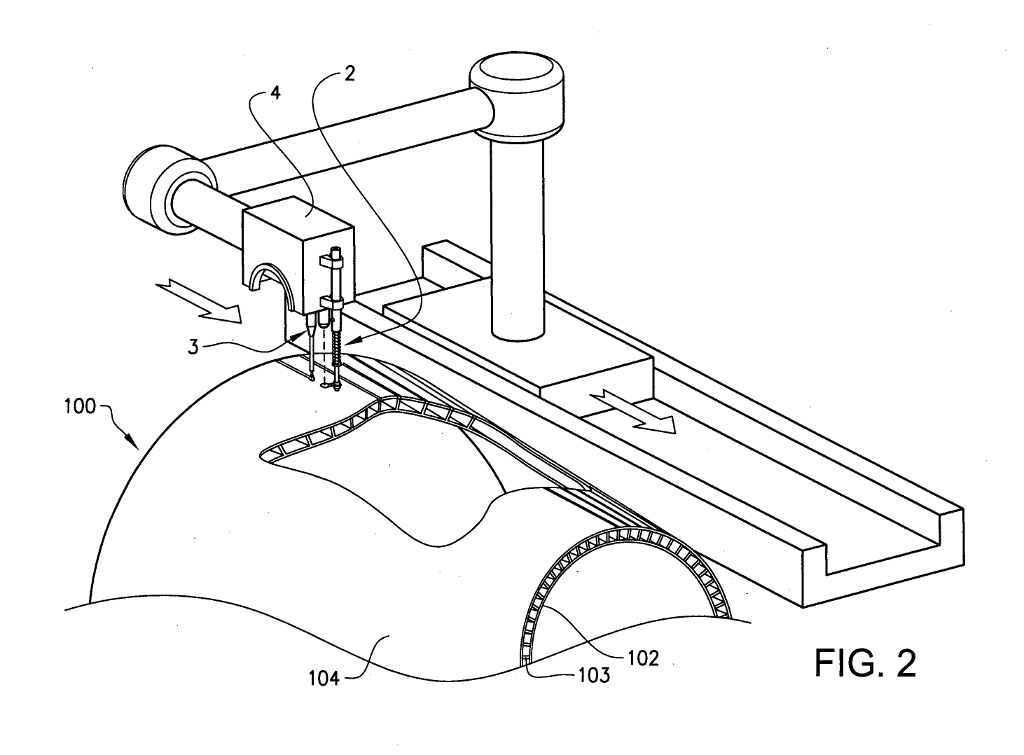

In FIG. 2, the outlet nozzle 100 is shown in a partly cut perspective view. The outlet nozzle 100 is formed by a sandwich type of wall structure. The oulet nozzle 100 is formed by providing an inner conical wall 102 with a plurality of circumferentially spaced walls 103 extending in a radial direction from an outer surface of the inner wall and an outer conical wall 104. An inner surface of the outer conical wall 104 is positioned in contact with the free edges of the radial walls 103 by relative movement in an axial direction of the conical inner and outer walls. The outer conical wall 104 is then attached to each of the free edges of the radial walls by welding.

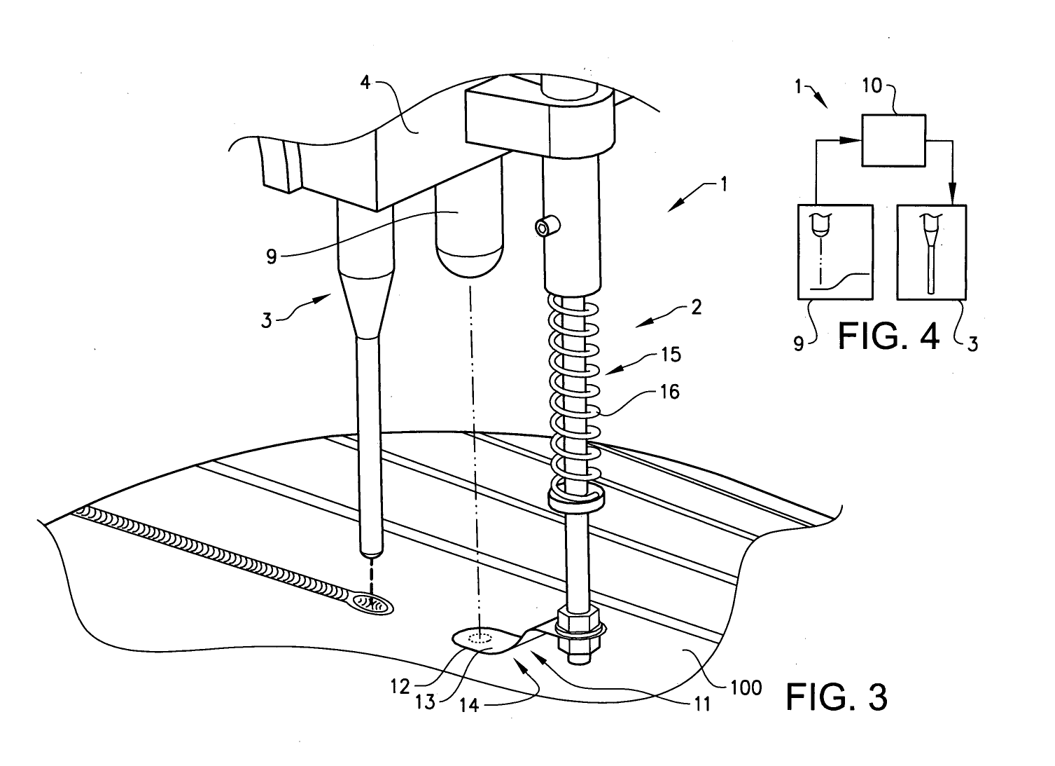

FIGS. 3 and 4 show the welding arrangement 1 in more detail. The distance determining device 2 comprises a means 9 for emitting an energy beam towards the surface of the workpiece 100. The device further comprises a contact member 11 with a first surface 12 configured to contact the surface of the workpiece 100 and a second surface 13 facing the energy beam emitting means 9. The contact member 11 forms a one-piece unit. The energy beam emitting means 9 is arranged for directing the energy beam to the second surface 13 of the contact member. The second surface 13 of the contact member 11 is located on an opposite side of the contact member in relation to the first surface 12. The contact member 11 comprises a substantially flat part 14, which comprises said first and second surfaces 12,13. Said flat part 14 forms a relatively thin plate-shaped part and is preferably formed by sheet metal.

The device 2 comprises a means 15 for forcing the contact member 11 in contact with said surface of the workpiece 100 during operation. Said forcing means 15 comprises a flexible element 16, which is configured to assume a state of higher potential energy in an active state for forcing the contact member 11 in contact with said surface of the workpiece during operation.

Said means 9 for emitting an energy beam is configured to emit a laser beam. Said means 9 for emitting an energy beam and said contact member 11 are arranged to be moved in unison during operation.

Further, the distance determining device 2 comprises a distance determining means 10 operatively connected to the energy beam emitting means 9 for determining the distance based on information associated to the energy beam.

The distance determining means 10, or controller, comprises a memory, which in turn comprises a computer program with computer program segments, or a program code, for determining the distance when the program is run.

The energy beam emitting means 9 is configured, to generate a signal with information associated to the energy beam. The controller 10 is configured to receive said signal with information associated to the energy beam. Further, the controller 10 is configured to determine one or more welding parameters and/or the position of a welding head of the welding apparatus 3 for controlling the welding process on the basis of information associated to the energy beam. The controller 10 is further configured to generate a signal comprising information regarding welding parameters and/or the position of a welding head of the welding apparatus 3. The welding apparatus 3 is configured to receive said signal with information regarding welding parameters and/or the position of a welding head.

The invention further relates to a method for determining a distance to a surface of a workpiece 100, comprising the steps of emitting an energy beam towards the surface of the workpiece and determining the distance based on information associated to the energy beam. The method comprises the further steps of positioning the contact member 11 with a first surface 12 in contact with the surface of the workpiece 100 and a second surface 13 facing the energy beam emitting means for receiving the energy beam.

According to a preferred embodiment, the method comprises the steps of determining a distance to a surface of a workpiece 100 and controlling the effection, preferably welding, based on the distance determination.

The invention further relates to a computer program comprising computer program segments for implementing the method when the program is run on a computer. The invention further relates to a computer program product comprising computer program segments stored on a computer-readable means for implementing the method when the program is nm on a computer.

The invention is not to be regarded as being limited to the illustrative embodiments described above, but a number of further variants and modifications are conceivable within the scope of the following patent claims.

Said effection of the surface of the workpiece is not limited to welding, but may instead be any other technique for joining metal objects, such as soldering, metal deposition or working one or several objects.

The outlet nozzle 100 is in the figures illustrated as a truncated cone, wherein the wall structure extends along a substantially straight line between two parallel planes in a cross section. However, the invention is not limited to welding along straight lines. Especially, the outlet nozzle wall structure may extend along a curved line between two parallel planes in a cross section. In such an application, welding is perfomed along a curved surface.

Further, the invention is of course not limited to the embodiment illustrated in FIGS. 1-3 with an arrangement 5 for linear movement. Instead, a robot arm arranged on a pedestal or rack may for example be used.

The welding means does not necessarily have to comprise a welding robot, but, according to an alternative, use is made of a conventional welding apparatus without autonomous functioning.

The distance determining device 2 can be used on its own, that is to for distance determination for other purposes, without various welding parameters or the movement of the welding means being controlled.

According to the embodiment above, the controller 10 is both configured to determine a distance to the workpiece based on information associated to the energy beam and to determine welding parameters for the welding process in response thereto. However, the two functions may be performed in two computers, one for each function. Further, it may not be necessary to in fact calculate said distance but instead directly control one or more welding parameters and/or the position of a welding head of the welding apparatus 3 for controlling the welding process on the basis of information associated to the energy beam.

1. A device for determining a distance to a surface of a workpiece, wherein the device comprises a means for emitting an energy beam towards the surface, and a contact member with a first surface configured to contact the surface of the workpiece and a second surface facing the energy beam emitting means, wherein the energy beam emitting means is arranged for directing the energy beam to the second surface of the contact member.

2. A device according to claim 1, wherein the second surface of the contact member is located on an opposite side of the contact member in relation to the first surface.

3. A device according to claim 1, wherein the contact member comprises a substantially flat part, which comprises the first and second surfaces.

4. A device according to claim 1, wherein the device comprises a means for forcing the contact member in contact with the surface of the workpiece during operation.

5. A device according to claim 4, wherein the forcing means comprises a flexible element, which is configured to assume a state of higher potential energy in an active state for forcing the contact member in contact with the surface of the workpiece during operation.

6. A device according to claim 1, wherein the means for emitting an energy beam is configured to emit a laser beam.

7. A device according to claim 1, wherein the means for emitting an energy beam and the contact member are arranged to be moved in unison during operation.

8. A device according to claim 1, wherein the device comprises a distance determining means operatively connected to the energy beam emitting means for determining the distance based on information associated to the energy beam

9. An arrangement for effecting a workpiece, comprising an apparatus configured to effect the workpiece, wherein the arrangement comprises a distance determining device according to claim 1 and the distance determining device is operatively connected to the apparatus for effecting the workpiece based on the distance determination.

10. An arrangement according to claim 9, wherein the apparatus is arranged behind the contact member in an direction of movement of the arrangement during operation.

11. An arrangement according to claim 9, wherein the apparatus comprises a welding device.

12. A method for determining a distance to a surface of a workpiece, comprising
emitting an energy beam towards the surface of the workpiece and determining the distance based on information associated to the energy beam, and
positioning a contact member with a first surface in contact with the surface of the workpiece and a second surface facing the energy beam emitting means for receiving the energy beam.

13. A method for effecting a workpiece, comprising determining a distance to a surface of a workpiece according to claim 11 and controlling the effection based on the distance determination.

14. A computer programmed with computer program segments for implementing the method as claimed in claim 12.

15. A computer program product comprising, computer program segments stored on a nontransitory computer-readable medium for implementing the method as claimed in claim 12.
